(19) United States
(12) Patent Application Publication
(10) Pub. No.: US 2014/0191743 A1
(43) Pub. Date: Jul. 10, 2014

(54) CURRENT MODE CONTROL ARRANGEMENT AND METHOD THEREOF

(71) Applicant: Texas Instruments Incorporated, Dallas, TX (US)

(72) Inventors: Seamus M. O'Driscoll, Cork (IE); David A. Grant, Cambridge, MA (US); Peter M. Meany, Cork (IE)

(73) Assignee: Texas Instruments Incorporated, Dallas, TX (US)

(21) Appl. No.: 14/232,115

(22) PCT Filed: Jan. 10, 2013
(86) PCT No.: PCT/EP2013/050420

§ 371 Date: Jan. 10, 2014

(30) Foreign Application Priority Data
Jan. 10, 2013 (GB) 1300427.0

(51) Int. Cl. H02M 3/156

(52) U.S. Cl. CPC H02M 3/156
USPC 323/282

(57) ABSTRACT

Control circuitry for providing a control signal in a pulse width modulating regulating power converter wherein an output parameter delivered by the converter is regulated by pulse width modulation of current within the converter, including circuitry for receiving a sensed output parameter of the converter; circuitry for deriving therefrom an analog average current demand signal corresponding to a current that would bring the converter into regulation; circuitry for receiving a sensed present value of the current within the converter to provide an analog signal representative thereof; circuitry for differencing the average current demand signal and the analog signal to provide an error signal; a compensator arranged to average the error signal to provide a second error signal; a sawtooth generator providing an analog signal as a pulse width modulation ramp; and a comparator to which the ramp is applied to generate the control signal at the output thereof.

The present invention relates to power converters and adapters and in particular provides a control regime for such converters and adapters based on a technique generally referred to in the art as Current Mode Control (CMC). More particularly still, the present invention seeks to realise control arrangements and methods for integrated circuits such as would be suitable for the control of ac-dc, dc-dc and dc-ac power converters, including brushless motor controllers and power inverters, such as may be found in solar photo-voltaic systems.

In a typical adapter/converter an ac mains or line voltage is rectified to an intermediate voltage that is then is regulated to a desired output voltage by a dc-dc converter. The present invention relates particularly although by no means exclusively to such a dc-dc converter. Since there is often a requirement that the output be electrically isolated from the mains or line input, the dc-dc converter is often configured as a switching regulation stage driving an isolating transformer and an inductive rectifying stage to deliver the output. Whether isolated or not, the switch of the switching stage often controls a magnetising current of an inductive element in the converter

Current mode control is described in the background section of the paper “Average Current Mode Control of Switching Power Supplies” by Lloyd Dixon and issued as an application note in 1990 by the Unitrode Corporation (now part of Texas Instruments Incorporated). Presently, a copy of the paper may be obtained at: http://www.ti.com/lit/an/slua079/slua079.pdf

In essence, current mode control is a two loop control system which controls both the current in the rectifying stage and the output voltage. To effect the control and desired regulation, signals representing both line current and output voltage are fed back in an isolated or non-isolated manner to a controller on the primary side of the transformer. In classical CMC, the on time of a switch driving the transformer primary is terminated when the current through the output inductor reaches a level set by an error signal derived from the output voltage. The technique effectively operates on the peak inductor current and as such may be referred to as Peak Mode Current Control (PMCC). As is well known in the art this peak current control technique is highly susceptible to noise and instability. Stability may be improvement by slope compensation whereby a ramping voltage is superimposed, on, for example, the error signal, however most of the time such a ramp will overcompensate, leading to slower response.

As is also well known in the art, an improvement to the classical approach may be made by employing Average Current Mode Control (ACMC). Here the sensed current through the inductor is applied to a current signal amplifier before or as it is compared with the sensed voltage or voltage error signal. The output of the amplifier is then compared with a ramp signal to effect the usual pulse width modulated (PWM) drive to the primary of the transformer. The amplifier is typically a high gain integrating amplifier, so that its output represents an average of its input. Moreover, it can be compensated, removing the need for slope compensation. It is often referred to as a current error amplifier (CEA).

CMC and ACMC is also highly applicable in non-isolated designs and PFC stages wherein the PWM signal may drive the output power switch directly.

ACMC is the primary topic of Dixon in the paper mentioned above. Further background is presented in Maxim Application note 3939 (from 2006) entitled “DC-DC Controllers use Average-Current-Mode-Control for Infotainment Applications” and presently available at: http://www.maximintegrated.com/app-notes/index.mvp/id/3939. In that paper, some advantages of ACMC are stated as follows: “By compensating the CEA with a feedback network, one accomplishes several things: tailor the current-sense signal to exhibit maximum gain at DC (for a buck converter, the inductor's DC current is equivalent to the converter's output current); allow the actual current-sense signal to pass unimpeded through the amplifier; and finally, dampen the high-frequency switching noise which is superimposed on the signal. The high gain of the CEA at DC allows this control scheme to accurately program the output current. In contrast, the current-sense signal in CMC has a flat gain, causing the system to exhibit a peak-to-average current error as a result of input voltage variations”.

For further background on CMC, the reader is referred to another Dixon paper entitled “Current Mode Control of Switching Power Supplies” (reissued by Texas Instruments in 2001) and presently available at: http://www.ti.com/lit/ml/slup075/slup075.pdf.

Despite its undoubted advantages over CMC, any ACMC includes an amplifier that is both integrating and compensated. As such, some response time compared to CMC will be lost. A serious drawback oc ACMC is the need for external compensating components. Generally, they add requirement for another pin to IC controller packages in order to apply external compensating components and this adds cost because these controllers are often in 7 or 8 pin packages, which is a significant part of overall controller cost. Reduction in pin count is therefore desirable. Response time will be lost for correction to loop disturbances but may also affect the response time auxiliary circuits such as in instantaneous overcurrent protection circuits. The present invention was made as a result of addressing these observations as the problem of retaining some of the advantages of CMC in a control regime exploiting ACMC.

It has been proposed to implement ACMC in a digital controller, as for example suggested by Purton (2002) in a paper entitled “Average Current Mode Control In Power Electronic Converters—Analog versus Digital” and presently available at: http://archive.itee.uq.edu.au/˜aupec/aupec02/Final-Papers/K-D-Purton.pdf. A digital implementation of slope compensation in a classical CMC peak control system as been proposed by Grote et al (2009) in the paper “Adaptive Digital Slope Compensation for Peak Current Mode Control” and presently available at: http://wwwlea.uni-paderborn.de/fileadmin/Elektrotechnik/AG-LEA/forschung/veroeffentlichungen/2009/ECCE2009-Grote.pdf

In accordance with the present invention there is provided apparatus and method as set forth in the claims.

In particular in one aspect thereof, the present invention provides a method of providing a control signal in a pulse width modulating regulating power converter wherein an output parameter delivered by said converter is regulated to a desired value by pulse width modulation of current within said converter, the method including the steps of: (a) sensing said output parameter; (b) deriving therefrom an analogue average current demand signal (Iavg_dem) corresponding to a current that would bring said converter into regulation; (c) sensing a present value of said current within said converter to provide an analogue signal representative thereof; (d) differencing said average current demand signal and said analogue signal to provide an error signal; (e) applying said error signal to a compensator, said compensator being arranged to average said error signal over time to provide a second error signal; (f) generating a sawtooth analogue signal as a pulse width modulation ramp; (g) applying said ramp to a comparator (34,43,52) to generate said control signal at the output thereof; and (h) simultaneously applying both said error signal and said a second error signal to said comparator such that the error signals are additively compared to said ramp by said comparator; whereby said control signal is responsive to both peak and average values of said current by means of said error signal and said second error signal respectively.

Moreover, in a further aspect thereof, the present invention provides control circuitry for providing a control signal in a pulse width modulating regulating power converter wherein an output parameter delivered by said converter is regulated to a desired value by pulse width modulation of current within said converter, the control circuitry including: circuitry for receiving a sensed output parameter of said converter; circuitry for deriving therefrom an analogue average current demand signal (Iavg_dem) corresponding to a current that would bring said converter into regulation; circuitry for receiving a sensed present value of said current within said converter to provide an analogue signal representative thereof; circuitry for differencing said average current demand signal and said analogue signal to provide an error signal; a compensator to which said error signal is applied, said compensator being arranged to average said error signal over time to provide a second error signal; a sawtooth generator for providing an analogue signal as a pulse width modulation ramp; and a comparator (34,43,52) to which said ramp is applied to generate said control signal at the output thereof; wherein both said error signal and said a second error signal are simultaneously applied to said comparator such that the error signals are additively compared to said ramp by said comparator; and whereby said control signal is responsive to both peak and average values of said current by means of said error signal and said second error signal respectively.

The present invention is suitable for the implementation of a current control loop in a switch mode power converter. It is further suitable for implementation in ac-dc, dc-dc, dc-ac, ac-ac power inverters, converters and adapters (herein referred to as power converters). It is able to combine the well understood advantages of peak current mode control with those of average current mode control. Implementation of this scheme may be by any arrangement or mix of analogue or digital control methods but the embodiments proposed here may give particular cost advantage by employing analogue PWM comparator systems combined with digital averaging or compensation schemes or both.

In order that features and advantages of the present invention may be further appreciated, embodiments will now be described by way of example only and with reference to the accompanying diagrammatic drawings, of which:

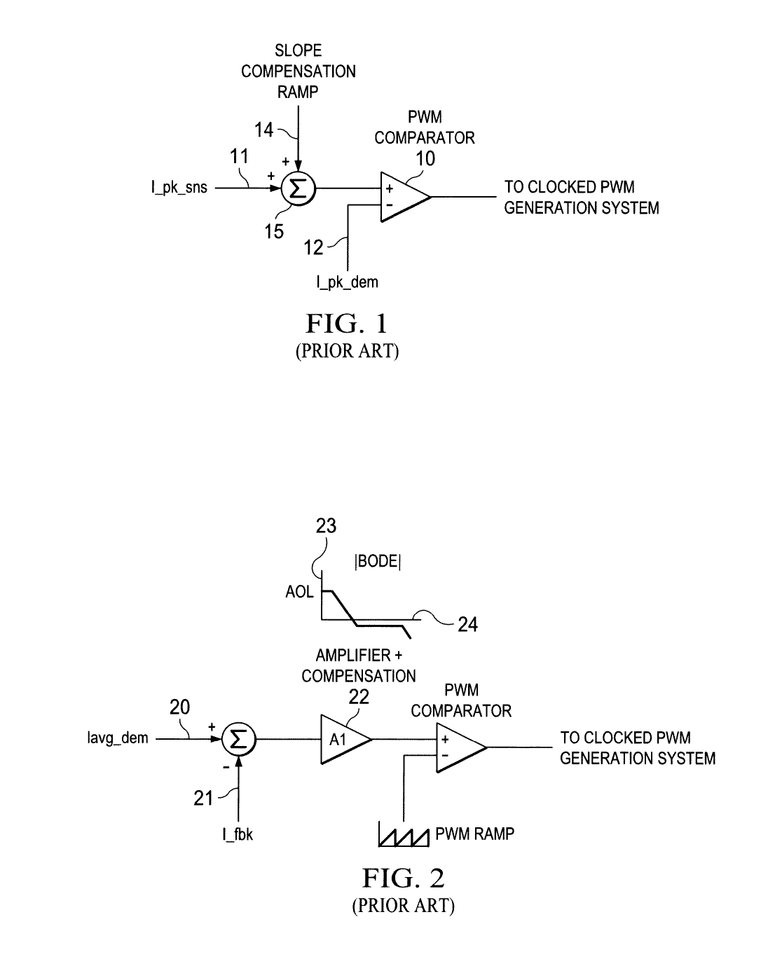

FIG. 1 represents circuitry for peak current mode control in accordance with the prior art;

FIG. 2 represents circuitry for average current mode control in accordance with the prior art;

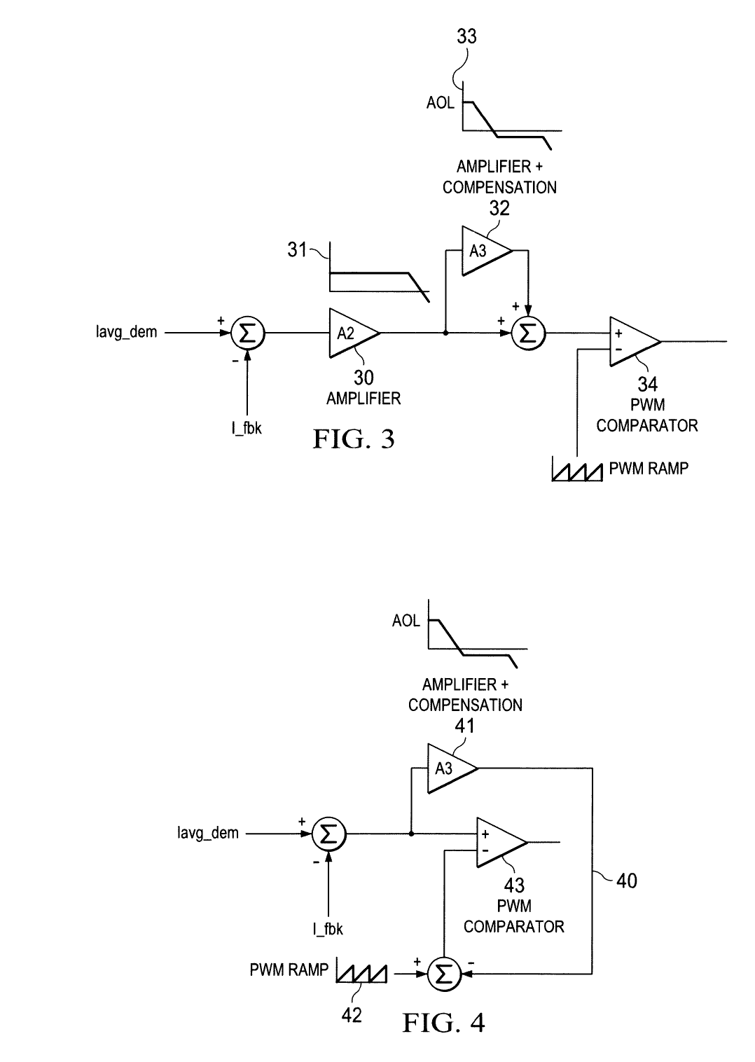

FIG. 3 represents a first embodiment of the present invention;

FIG. 4 represents a second embodiment of the present invention;

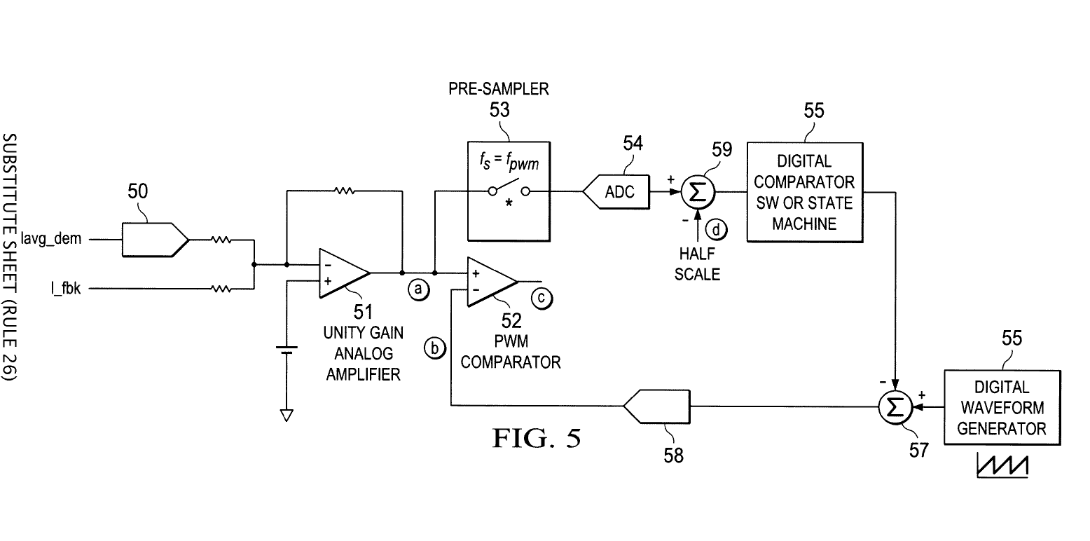

FIG. 5 represents a third preferred embodiment of the present invention;

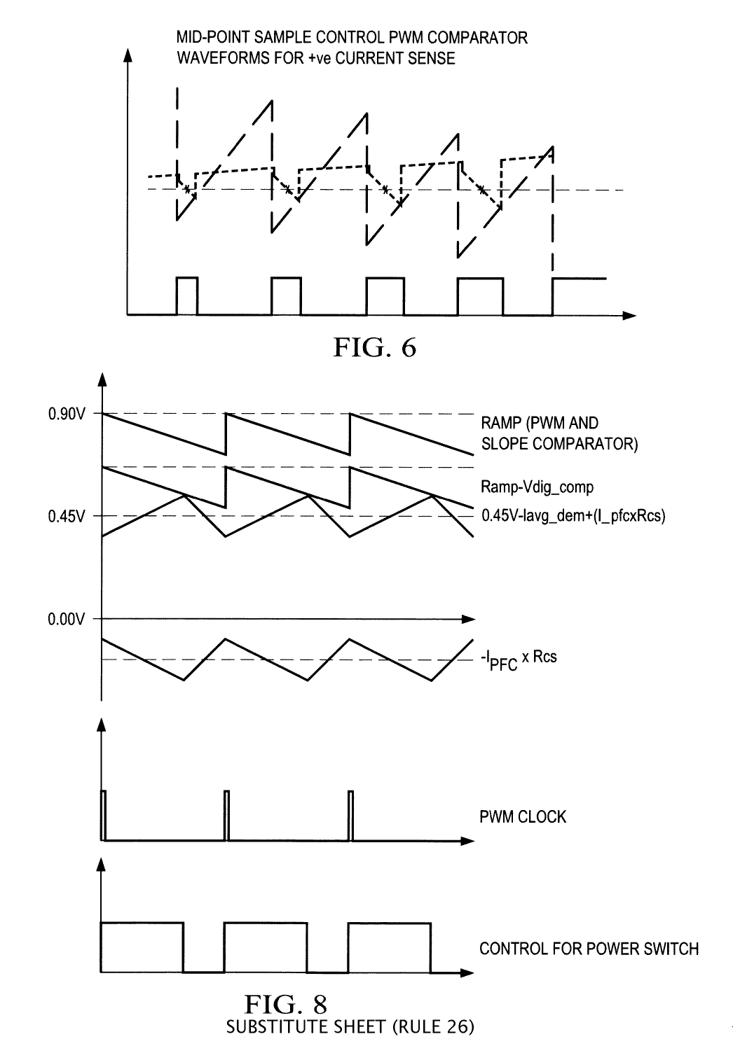

FIG. 6 represents waveforms associated with the embodiment of FIG. 5;

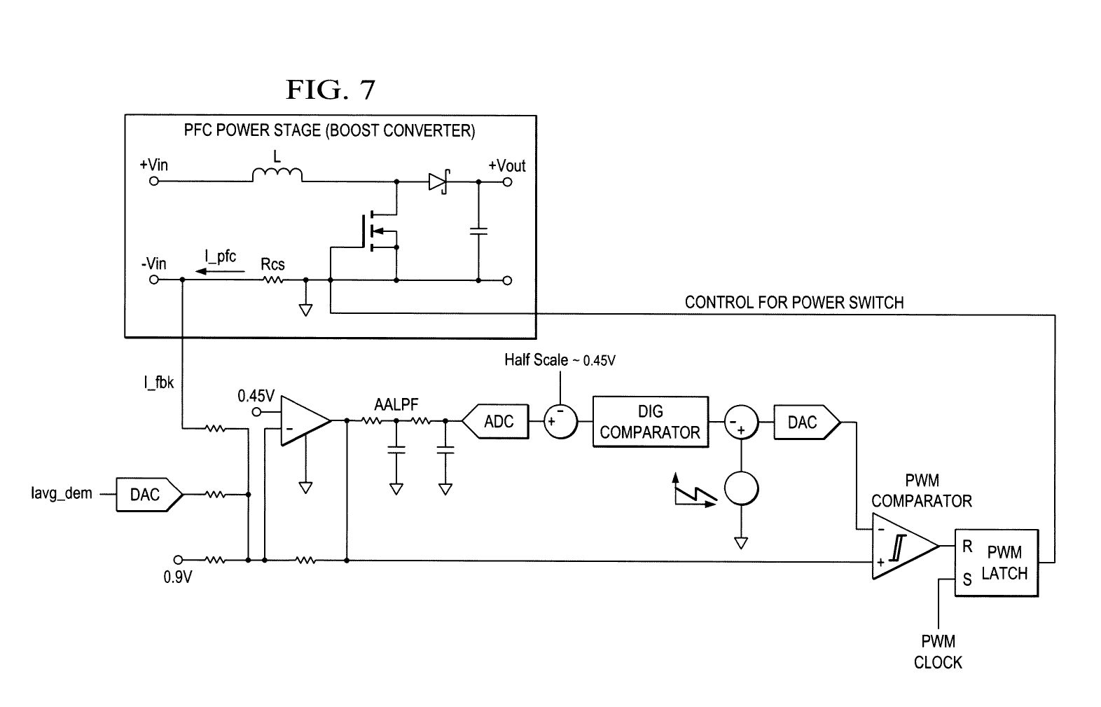

FIG. 7 represents a fourth preferred embodiment of the present invention;

FIG. 8 represents waveforms associated with the embodiment of FIG. 7; and

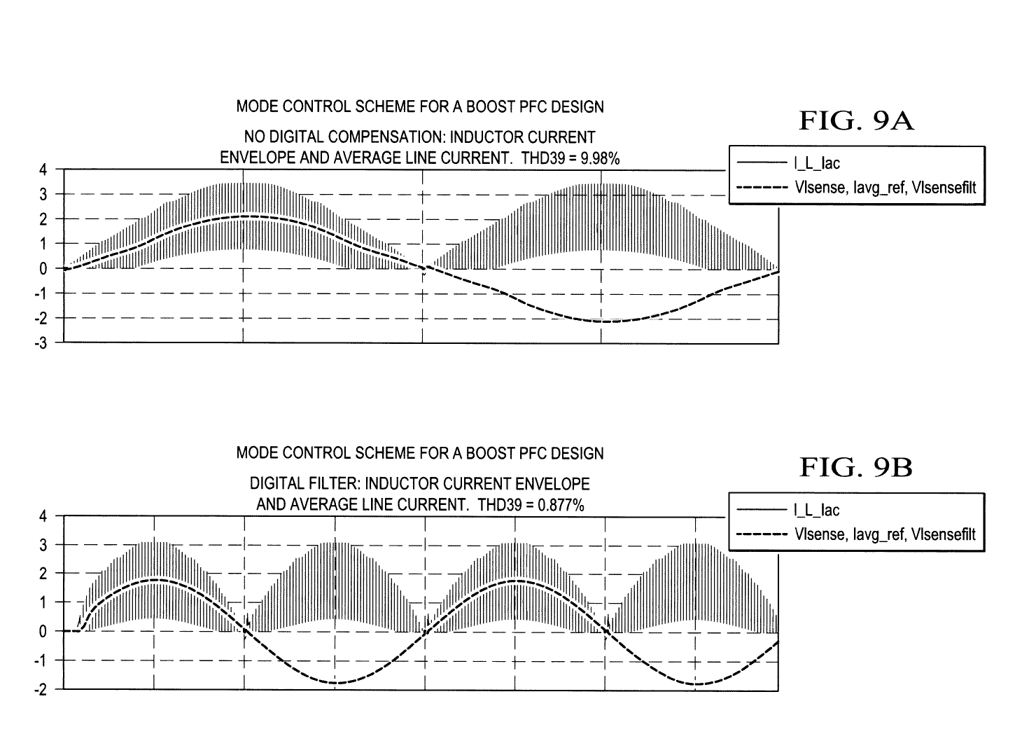

FIG. 9 represents further waveforms associated with the embodiment of FIG. 5;

FIG. 1 shows a typical analogue peak current control comparator section of a converter of the prior art, including a comparator 10, which terminates a switching pulse width at a width to ensure that the sensed output current 11 (I_pk_sns) matches a demand level for the peak current 12 (I_pk_dem). In steady state I_pk_dem will be constant. Slope compensation 14 is applied to the comparator in addition to I_pk_sns via a summer 15 to correct for peak to average error and to correct for tendency to exhibit sub-harmonic instability when operating at duty cycles in excess of 50%. Slope compensation could alternatively be by subtraction of a synchronous compensating ramp from the I_pk_dem signal. The primary advantage of peak current mode control is that there is essentially instantaneous (inside a PWM period) correction of the peak current attained for disturbances such as in supply voltage. The primary disadvantage of peak current mode control is that generally it is desirable to control an average current and whereas slope compensation may correct to a large extent for peak to average difference, it is difficult to obtain the correct value for slope compensation for varying operating conditions and parameter values, such as power magnetising inductance.

FIG. 2 shows a typical analogue average current control comparator section which terminates a switching pulse width at a width to ensure that the error between a demand (20) and a sensed (21) current will tend to zero according to a closed loop containing a compensated amplifier 22 (A1) with integral action. Integral action in the Al amplifier will have an averaging function so that the average of the sensed signal will be driven to match the demand. The sensed signal is generally arranged so that its average matches the average of the quantity being controlled. Some schemes are more elaborate to ensure that this is the case. For example schemes which want to control an average magnetising current may sense a switch current which represents the magnetising current while the power switch is on and may add in a synthesised off-state current so that the sensed current can be made equal to the magnetising current. A bode magnitude plot shows a zero and then flat attenuation. It will be observed that there is marked attenuation at and above tow PWM frequency 24. This attenuation determines the amount of switching ripple at the output of A1 and indicates the amount of averaging given by the closed current loop. For good averaging this gain is generally chosen to attenuate switching ripple in the sensed current waveform by at least a factor of 10. This fact means that the primary disadvantage of conventional current mode control is that there is not good instantaneous correcting response to a disturbance mechanism in the power stage cycle current. This is the primary drawback with analogue average current mode control.

In digital controllers it might be possible to calculate a true cycle average, every cycle at the full PWM bandwidth in order to provide a faster response to extreme events, but this would be resource intensive to cause higher cost or higher control power requirement or probably both. Except at the very high end of the market, low cost and low power consumption are essential requirements. This is an example of the inherent advantage of low power consumption of an analogue approach to power converter controller design, particularly for the mass market, that remains in favour today. The present invention, in one aspect thereof, provides an improvement in speed of response whilst retaining the analogue advantage.

FIG. 3 shows a re-arrangement of the standard scheme in FIG. 2, wherein the compensation function is separated out from a DC gain function. The gain function is provided by amplifier A2 (30) as indicated by its bode plot 31. The compensation function is implemented in an amplifier A3 (32) which is arranged to have a corresponding bode plot 33. The function includes the low frequency integrator to drive to low steady state error, the zero function to provide phase margin and a levelling off at low gain to provide averaging up to and above PWM frequency.

As such the arrangement could be made to function in a way exactly equivalent, although there would be little point in so doing since no more than the same result would be obtained at the expense of adding a second amplifier. What it is important to note the separation introduces a further degree of freedom in that the A2 amplifier gain may be higher than overall gain of the flat gain portion in the bode plot 23 of FIG. 2, including at the PWM frequency. This means that higher or full switching ripple current is visible at the comparator input, thereby allowing the rapid feedforward disturbance rejection advantage of peak current mode control to be introduced into the average current mode control arrangement. The A2 amplifier function is often required in any case for scaling, sensed current signal inversion, dc offset or for implementing the input summing function between demand and sense to create the control loop forward path input error signal. In such systems, there is no additional overhead in implementing the present invention.

Fast response applies to response within 1 or 2 or a few switching periods timeframe for, for example power semiconductor transient temperatures or magnetic material saturation effects. The switching noise problem associated with CMC applies to timing jitter around the pulse width termination and is a higher frequency effect. These effects may be separated by 1 or 2 decades and thus may be managed, it being recall that A3 is an averaging/integrating arrangement and A2 could be attenuated above the PWM frequency.

FIG. 4 shows an alternative embodiment wherein the output 40 of the compensation stage 41 subtracts from the PWM ramp 42 at the other input of the PWM comparator 43.

There is advantage in this embodiment since the PWM ramp now serves the dual purpose of being both a PWM generating saw-tooth ramp and as applied to the comparator delivers a slope compensating signal for the peak current mode component from A2 which delivers the signal with high switching ripple content directly to the comparator. As an alternative, the error signal could be subtracted from the ramp. It will also be observed that in FIG. 4 the A2 amplifier of the arrangement of FIG. 3 is absent. This represents a minimal implementation which may be adequate in some applications.

It will be appreciated that the embodiments of FIGS. 3 and 4 show a fundamental aspect of the present invention, whereby the current loop compensation and averaging function is separated out into a separate summing stage to allow the simultaneous application of the signal with non-averaged switching ripple content to appear at the PWM comparators 34 and 43 respectively.

FIG. 5 shows a yet further embodiment, whereby the averaging and compensation function is implemented digitally and combined with a digital PWM ramp generation function.

As is common in digital controllers, I_{avg}_{_{—}}_{dem} is a computed quantity and is applied via digital to analogue converter (DAC) 50. This can be advantageous since it would, depending upon the required performance/complexity of a converter allow line current waveshaping as described in the International Patent Application published as WO2012013690 and other corrections such as for power factor to be applied by digital summation.

In the analogue domain, the signal is applied to unity gain amplifier 51 which functions in a way analgous to amplier A2 described previously. The amplifier output feeds a PWM comparator 52 as before and is also sampled (53) and converter to the digital domain by an analogue to digital converter (ADC) 54.

Unity Gain Amplifier 51 is used to create the loop input difference function to create the error by using it in summing amplifier mode and it is used to bias signals for single supply rail operation. The pre-sampler 53 represents a track and hold stage whereby the sampling aperture timing may be set within the PWM period. ACMC is a particularly valuable technique where there is Continuos Conduction Mode (CCM) operation, or transitions into CCM. During CCM mode, a sampling instant which is set at the mid-point of a switch current pulse will represent a true average of an inductor magnetising current. This quantity is then a good choice as input to the compensator/integrator stage. The integrator (and high DC gain) section will act to drive the error at the sample instant to be close to zero (ideally zero). The sampling point timing may be manipulated according to other schemes to be equivalent to a mathematical calculation function and thereby obviate the requirement for having to put a calculation stage between the sampling capture value and the digital compensator. These schemes are valuable in the case where the power stage current is in Discontinuous Conduction Mode (DCM) or alternatively where the switched current is not directly representative of the quantity being controlled. For instance, sampling instant adjustment could be used to make a sampled primary current in a Flyback converter be directly representative of the output current of the Flyback converter.

The analogue circuitry is biased for unipolar operation (single voltage supply) so it is necessary also to bias the digital system around a similar point, in the digital numeric domain. This is achieved by the addition of a half scale voltage to the digital sample in adder 59. Thus, the digital control loop may stabilise at a point so that the input to the digital integrator is close to or ideally at zero. In system biased about ground (positive and negative supplies), the bias addition may be omitted.

Compensation and integration as aforesaid is applied digital by software or state machine in block 55. A PWM ramp is digitally generated in block 56 and summed (57) with the compensated output. The resultant value is returned to the analogue domain by DAC 58 and applied to the comparator 52. In a preferred implementation, low cost ip blocks are used, for example the DACs may be of the Kelvin Varley divider type.

The operating waveforms of the embodiment of FIG. 5 are illustrated in FIG. 6, wherein waveforms (a) and (b) represent the waveform present at the corresponding points marked on FIG. 5, i.e. the inputs to the PWM comparator 52. From these waveforms a yet further advantage of the invention may be appreciated.

As may be seen, the PWM comparator is comparing signals with 2 slopes of opposite sense and hence there will be greater noise immunity, lower propagation delay advantage and requirement for lower comparator hysteresis. The segmentation here between analogue and digital means of generating the control signal that is the comparator output means that the analogue amplifier now purely has a dc gain and offset function, which is relatively easy to achieve in design and layout. Current loop pole and zero requirements tend to be low in frequency and would consume large area if implemented with analogue silicon. Digital implementation of the low frequency pole and zero is easier in many mixed signal technologies, particularly when combined with functions such as PWM ramp generation. This embodiment, with digital compensation, would allow, for example, the saving of a pin on a controller integrated circuit (IC) package, over traditional analogue systems, where the compensation is generally performed with discrete resistors and capacitors connected via a pin to the output of a transconductance type. A particular advantage is that required compensation may be specified as usual (i.e. by analogue design techniques) or even taken from existing analogue designs and translated into variables available to the digital compensator or state machine and the waveform generator. Indeed in an IC controller, these latter may be provided as a general purpose generator/filter/converter block that may be programmed accordingly.

The waveforms in FIG. 6 show how a sensed quantity may be driven to match demand in a closed system with integral action. The waveform denoted (b) is filtered to be a smooth PWM sawtooth ramp. The level (d) in FIGS. 5 and 6 represents a mid-scale bias point in the digital numeric domain. Integral action in the digital compensator drives the system to create zero error at the input to the digital compensator so that the signal at (a) in FIGS. 5 and 6 at the sampling instants will be driven to equal the digital (mid-scale) bias point. For the waveforms in FIG. 6, the sampling instant is chosen to be in the middle of each switching pulse or half way along the switch current ramp waveforms shown in FIG. 6(a). FIG. 6(c) shows the PWM comparator signal which drives the power switch. Note that in a system where the sampling instant is pre-computed based on previous switching cycle information, only in the steady state would it possible to have a sampling instant at the absolute mid-point. This example for a sensed current waveform in FIG. 6(a) shows a case of continuous current conduction. The switch current at the start of the pulse width has a DC bias. For this case a sample at the mid-point of the pulse width or half way through the current ramp will represent the average value for the current. As will be appreciated, there are other arrangements wherein a sampling instant at a point other than at the mid-point may be an advantageous choice.

In the digital domain, the appropriate choice of a single sampling point per PWM cycle may be a cycle averaging process which avoids the need for oversampling at sampling rates much higher than the PWM frequency. The sampling point is pre-computed, off-line, based on previous PWM cycle(s). The digital compensator is clocked at PWM frequency, since it has been found that in many applications the technique is robust enough not to require oversampling to produce an adequate average and thereby avoids the computational overhead associate therewith, which is particularly advantageous in meeting a no load converter current demand specification.

FIG. 7 shows a further embodiment showing dc offsets for a unipolar design. There is an additional anti-aliasing filter 70, AALPF, shown which allows for the averaging function to be separated into analog implementation and would allow greater freedom on the ADC sampling instant. Generally one ADC sample per PWM cycle is used and the sampling instant is chosen so that the sampled current will be representative of the cycle average current. Use of an anti-aliasing filter allows a yet further degree of freedom in separating the averaging function from the compensation function.

The an anti-aliasing (low pass) filter 70 may be used to create an average of the current loop error signal. This will mean that the sampled signal at the ADC input will represent the current loop error average, irrespective of where the sampling point is located within the switching period. It may not require a pole at such low frequencies as for the pole and zero in the previous embodiments and hence be lower cost by employing smaller capacitor value. This filter may be single or high order pole. In some designs multi-cycle averaging alone will be sufficient for good power factor correction, moreover many sample points within each PWM cycle may be combined to build a cycle average, should that be advantageous. An overall benefit of this invention is that the averaging function is implemented separate from the control loop integration and compensation function.

FIG. 7 shows how a current mode PWM control scheme, similar to that of FIG. 5, is applied in a Boost Power Factor Correction Stage. Assume that a subsequent load is drawing energy from Vout. This load is not shown across Vout. The main waveforms associated with this are shown in FIG. 8. The significant differences between this controller and that of FIG. 5 is that there is a 2 pole anti-aliasing filter shown (AALPF block in FIG. 7) before the ADC and secondly this circuit is set up to cater for a negative going current sense signal. The AALPF makes the system more independent of sampling point as this analog block performs the averaging function. This filter has its cut-off frequency greater than the current loop bandwidth (which will be determined by the parameters in the digital compensator DigComp block) and substantially less than the PWM frequency. The system response to this filter characteristic is not very sensitive and a single pole filter could also be used. The signal out of the AALPF will be substantially smooth DC for steady state operation of this power stage. For our example system the AALPF pole(s) are set at 25 KHz for a system with a PWM frequency of 100 KHz. The digital compensator implements an integrator at low frequencies and a zero at 1 KHz to cancel this integrator and apply flat and very low gain at frequencies above 1 KHz. This means that the signal out of the Dig Comp block are of the same order of magnitude as the current loop bandwidth. The ADC operates on a single sample per PWM period and in this system with AALPF may be at any fixed point in the PWM period. Residual PWM frequency ripple and noise at PWM frequency suggests that for practical reasons a quiet time, such as mid-way through the Control On pulse will give best results.

This system is biased about 0.45V in the analog domain and signals operate over a dynamic range of between 0V and 0.9V. The input summing inverting amplifier in FIG. 7 may implement a DC gain and in this case we choose G=−1 and therefore the resistors in this input section will all be of equal value. The voltage corresponding to current feedback (I_fbk) will drive negative in this case because of the position of the power stage current sense resistor R_{CS} with respect to ground. The +0.9V input to the inverting amplifier acts to offset this current so that it will be biased about 0.45V. The demand signal, Iavg_dem, is biased about 0.45V so that the entire system has a quiescent operating point set around 0.45V. The set-up for negative going current sense, for this system requires that the sense of Iavg_dem will be different to the demand in FIG. 5 so that increasing values for current demand will require voltages increasing from 0.45V at the output of the Iavg_dem DAC in FIG. 7. Iavg_dem=0.45V will set zero current demand. Further, the set-up for negative going current sense, will necessitate a PWM sawtooth ramp with the ramp slope of opposite sense to that in FIG. 5. This is shown in the top waveform in FIG. 8.

Referring again to FIG. 7, consider increasing the average current demand level by increasing the the voltage out of the Ivg_dem DAC to above 0.45V will cause the input to the ADC to decrease and will cause the output of the digital compensator to integrate downwards and subtract less dc value (or slowly varying value) from the sawtooth ramp to cause the signal at the negative input of the comparator to increase and thereby tend to increase the control pulse width for the power converter main switch. Consider also that the power current I_pfc tends to increase in magnitude due to some power system parameter or operating condition change. This will cause the signal into the ADC to increase in value, the output of the digital compensator will increase and tend to subtract more from the sawtooth ramp and therefore tend to decrease the control pulse width for the power switch. These mechanisms illustrate how there is a closed loop control system for the average current in action, whereby integrating action in the digital compensator will drive the system to create zero error at the input to the digital compensator.

The waveforms in FIG. 8 represent a steady state operating condition. Control action transients or transients in operating conditions will cause the bias levels, illustrated by the dashed lines in FIG. 8 to vary.

Generally, the embodiments set forth offer Average Mode Current Control advantages, combined with Peak Mode Advantages, that is to say advantages include the following: peak current mode attribute of rapid cycle by cycle protection; peak current mode attribute of line disturbance rejection; average current mode attribute of high quality Power Factor Correction; and average current mode attribute of superior average current limit control.

In the experience of the inventors, the structure has proved particularly useful in Buck PFC and Boost PFC designs, High density 2 Stage Adaptors <75 W Input (Reduction in Bulk Capacitance Volume Requirement) and Quasi-Average Current Control (with Synthesised Secondary side average current control for Flyback). Some embodiments of the present invention may have increased sensitivity to switching edge jitter than ACMC but other ACMC benefits are achieved such as Constant Current Mode Control for power or current limit or reduced THD in a PFC application, in the presence of DCM mode to CCM (discontinuous to continuous magnetising current) mode transition. An ideal target market for the present invention, for example, is lower power and lower cost applications, where some increased PW jitter is acceptable but where there are requirements such as achieving Power Factor >0.9.

FIG. 9 demonstrates that the hybrid control system in accordance with the present invention works extremely well and in particular FIGS. 9(a) and 9(b) are to show the performance advantage with the digital compensator.

FIG. 9 (a) represents the performance of the hybrid system of FIG. 5 but with the digital compensator output disconnected. This gives performance similar to that which one would get with peak current mode control of the prior art only, in that there is a clearly visible error in the average input current, as the power inductor current transitions between DCM and CCM modes, although it is acknowledged that this system would not represent an optimal implementation of peak current mode control.

FIG. 9 (b) represents performance of the full hybrid system of FIG. 5. This system shows extremely low THD, computed as the sum of all line current harmonics up to the 39th. This illustrates an advantage of the digital compensator over prior art analogue average current mode control schemes. Analog amplifiers are practically restricted in maximum DC gain (by limited operational amplifier AOL) whereas high DC gains are easily achievable in the digital domain. This increased digital gain increases the overall performance of the current loop and reduces THD in a PFC application.

1. A method of providing a control signal in a pulse width modulating regulating power converter wherein an output parameter delivered by the converter is regulated to a desired value by pulse width modulation of current within the converter, the method comprising:
(a) sensing the output parameter;
(b) deriving therefrom an analog average current demand signal corresponding to a current that would bring the converter into regulation;
(c) sensing a present value of the current within the converter to provide an analog signal representative thereof;
(d) differencing the average current demand signal and the analog signal to provide an error signal;
(e) applying the error signal to a compensator, the compensator being arranged to average the error signal over time to provide a second error signal;
(f) generating a sawtooth analog signal as a pulse width modulation ramp;
(g) applying the ramp to a comparator to generate the control signal at the output thereof; and
(h) simultaneously applying both the error signal and the a second error signal to the comparator such that the error signals are additively compared to the ramp by the comparator

2. A method as claimed in claim 1 and comprising the step of, after step (d) and before step (h):
(i) applying the error signal to an analog amplifier, the amplifier having a substantially constant gain across a bandwidth extending from dc to at least the frequency of the pulse width modulation to provide an amplified error signal; and in step (h) applying the amplified error signal instead of the error signal.

3. Control circuitry for providing a control signal in a pulse width modulating regulating power converter wherein an output parameter delivered by the converter is regulated to a desired value by pulse width modulation of current within the converter, the control circuitry including:
circuitry for receiving a sensed output parameter of the converter;
circuitry for deriving therefrom an analog average current demand signal corresponding to a current that would bring the converter into regulation;
circuitry for receiving a sensed present value of the current within the converter to provide an analog signal representative thereof;
circuitry for differencing the average current demand signal and the analog signal to provide an error signal;
a compensator to which the error signal is applied, the compensator being arranged to average the error signal over time to provide a second error signal;
a sawtooth generator for providing an analog signal as a pulse width modulation ramp; and
a comparator to which the ramp is applied to generate the control signal at the output thereof; wherein both the error signal and the a second error signal are simultaneously applied to the comparator such that the error signals are additively compared to the ramp by the comparator.

4. Control circuitry as claimed in claim 3 and wherein the error signal includes a component at the pulse width modulation frequency.

5. Control circuitry as claimed in claim 4 wherein the error signal is attenuated above the pulse width modulation frequency.

6. Control circuitry as claimed in claim 3 wherein the error signal or second error signal is applied to one comparator input, and whichever of the two signals not so applied are subtracted from the pulse width modulation ramp applied to the other comparator input.

7. Control circuitry as claimed in claim 3 and wherein the generator and compensator are digital.

8. Control circuitry as claimed in claim 3 wherein the compensator comprises an integrating analog amplifier

9. Control circuitry as claimed in claim 7 and including an analog to digital converter receiving the error signal and providing an input to the digital compensator.

10. Control circuitry as claimed in claim 9 and wherein the output of the analog to digital converter is sampled to provide input to the compensator.

11. Control circuitry as claimed in claim 10 wherein samples are averaged.

12. Control circuitry as claimed in claim 11 wherein the output of the analog to digital converter is sampled once per pulse width modulation cycle.

13. Control circuitry as claimed in claim 12 and wherein the output of the analog to digital converter is sampled at the midpoint of a pulse width modulation cycle.

14. Control circuitry as claimed in claim 12 and wherein the output of the analog to digital converter is sampled at a point computed from a history of previous pulse width modulation cycles

15. Control circuitry as claimed in claim 12 and wherein the output of the analog to digital converter is sampled at the midpoint of a pulse width modulation cycle when the converter is in continuous conduction and at another point otherwise.

16. Control circuitry as claimed in claim 7 and wherein the digital compensator is clocked at pulse width modulation frequency.

17. Control circuitry as claimed in claim 7 and wherein the digital compensator is biased for unipolar operation of the circuitry.

18. Control circuitry as claimed in claim 3 and including an anti-aliasing filter and wherein the comparator triggers on opposing slopes.

20. (canceled)

19. Control circuitry as claimed in claim 3 including an analog amplifier to which the error signal is applied, the amplifier having a substantially constant gain across a bandwidth extending from dc to at least the frequency of the pulse width modulation to provide an amplified error signal; and wherein the amplified error signal is applied to the comparator instead of the error signal.

22. (canceled)

23. (canceled)

24. (canceled)

20. A power converter including a control circuitry as claimed in claim 3.
